(19) United States
(12) Patent Application Publication
(10) Pub. No.: US 2018/0375132 A1
(43) Pub. Date: Dec. 27, 2018

(54) REFERENCE OPEN-CIRCUIT-VOLTAGE CELL FOR REDOX FLOW BATTERY

(71) Applicant: UniEnergy Technologies, LLC, Mukilteo, WA (US)

(72) Inventors: Liyu Li, Bellevue, WA (US); Guanguang Xia, Everett, WA (US); Qingtao Luo, Mukilteo, WA (US); Lijun Bai, Mukilteo, WA (US); Jinfeng Wu, Mukilteo, WA (US); Yueqi Liu, Mukilteo, WA (US)

(73) Assignee: UniEnergy Technologies, LLC, Mukilteo, WA (US)

(21) Appl. No.: 16/014,813

(22) Filed: Jun. 21, 2018

Related U.S. Application Data
(60) Provisional application No. 62/523,136, filed on Jun. 21, 2017.

(51) Int. Cl. H01M 8/04537; H01M 8/18

(52) U.S. Cl. CPC H01M 8/04544; H01M 8/04634; H01M 8/188

(57) ABSTRACT

In one embodiment, a redox flow battery includes an electrochemical cell in fluid communication with anolyte and catholyte working electrolytes, and a primary OCV cell to measure the potential difference between the positive and negative working electrolyte, and a reference OCV cell to measure the potential difference between the reference cell working electrolyte, which is one of the anolyte and catholyte working electrolytes, and a reference electrolyte, wherein the reference electrolyte has a known potential. In another embodiment, a method of operating a redox flow battery includes calculating the potential values of the anolyte and catholyte working electrolytes based on the known potential values of the reference electrolyte and the first and second potential difference values obtained from the primary OCV cell and the reference OCV cell.

### CROSS-REFERENCE TO RELATED APPLICATION

This application claims the benefit of U.S. Provisional Application No. 62/523136, filed Jun. 21, 2017, the disclosure of which is hereby expressly incorporated by reference herein in its entirety.

### BACKGROUND

Concerns over the environmental consequences of burning fossil fuels have led to an increasing use of renewable energy generated from sources such as solar and wind. The intermittent and varied nature of such renewable energy sources, however, has made it difficult to fully integrate these energy sources into existing electrical power grids and distribution networks. A solution to this problem has been to employ large-scale electrical energy storage (EES) systems. These systems are widely considered to be an effective approach to improve the reliability, power quality, and economy of renewable energy derived from solar or wind sources.

In addition to facilitating the integration of renewable wind and solar energy, large scale EES systems also may have the potential to provide additional value to electrical grid management, for example: resource and market services at the bulk power system level, such as frequency regulation, spinning reserves, fast ramping capacity, black start capacity, and alternatives for fossil fuel peaking systems; transmission and delivery support by increasing capability of existing assets and deferring grid upgrade investments; micro-grid support; and peak shaving and power shifting.

Among the most promising large-scale EES technologies are redox flow batteries (RFBs). RFBs are special electrochemical systems that can repeatedly store and convert megawatt-hours (MWhs) of electrical energy to chemical energy and chemical energy back to electrical energy when needed. RFBs are well-suited for energy storage because of their ability to tolerate fluctuating power supplies, bear repetitive charge/discharge cycles at maximum rates, initiate charge/discharge cycling at any state of charge, design energy storage capacity and power for a given system independently, deliver long cycle life, and operate safely without fire hazards inherent in some other designs.

In simplified terms, an RFB electrochemical cell is a device capable of either deriving electrical energy from chemical reactions, or facilitating chemical reactions through the introduction of electrical energy. In general, an electrochemical cell includes two half-cells, each having an electrolyte. The two half-cells may use the same electrolyte, or they may use different electrolytes. With the introduction of electrical energy, species from one half-cell lose electrons (oxidation) to their electrode while species from the other half-cell gain electrons (reduction) from their electrode.

Multiple RFB electrochemical cells electrically connected together in series within a common housing are generally referred to as an electrochemical “stack”. One or more stacks electrically connected, assembled, and controlled together in a common container are generally referred to as a “battery”, and multiple batteries electrically connected and controlled together are generally referred to as a “string”. Multiple strings electrically connected and controlled together may be generally referred to as a “site”. Sites may be considered strings on a larger scale.

A common RFB electrochemical cell configuration includes two opposing electrodes separated by an ion exchange membrane or other separator, and two circulating electrolyte solutions, referred to as the “anolyte” and “catholyte”. The energy conversion between electrical energy and chemical potential occurs instantly at the electrodes when the liquid electrolyte begins to flow through the cells.

To meet industrial demands for efficient, flexible, rugged, compact, and reliable large-scale ESS systems with rapid, scalable, and low-cost deployment, there is a need for improved RFB systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment of the present disclosure, a redox flow battery is provided. The redox flow battery includes: an electrochemical cell in fluid communication with anolyte and catholyte working electrolytes, and a primary OCV cell to measure the potential difference between the positive and negative working electrolyte; and a reference OCV cell to measure the potential difference between the reference cell working electrolyte, which is one of the anolyte and catholyte working electrolytes, and a reference electrolyte, wherein the reference electrolyte has a known potential.

In another embodiment of the present disclosure, a method of operating a redox flow battery is provided. The method includes: providing an electrochemical cell in fluid communication with anolyte and catholyte working electrolytes, and a primary OCV cell to measure a first potential difference between the positive and negative working electrolyte, and a reference OCV cell to measure a second potential difference between the reference cell working electrolyte, which is one of the anolyte and catholyte working electrolytes, and a reference electrolyte, wherein the reference electrolyte has a known potential; and calculating the potential values of the anolyte and catholyte working electrolytes based on the known potential values of the reference electrolyte and the first and second potential difference values obtained from the primary OCV cell and the reference OCV cell.

In any of the embodiments described herein, the reference electrolyte may have ions of the same metal as the reference cell working electrolyte.

In any of the embodiments described herein, the reference electrolyte and the reference cell working electrolyte may include an initial electrolyte mixture of V³⁺ and V⁴⁺ ions or one of V³⁺ and V⁴⁺ ions.

In any of the embodiments described herein, the reference electrolyte and the reference cell working electrolyte may be both catholytes or both anolytes.

In any of the embodiments described herein, one of the reference electrolyte and the reference cell working electrolyte may be a catholyte and the other may be an anolyte.

In any of the embodiments described herein, the state of charge of the reference electrolyte may be between 0% and 100%.

In any of the embodiments described herein, the state of charge of the reference electrolyte may be between 30% and 60%.

In any of the embodiments described herein, the state of charge of the reference electrolyte may be between 40% and 50%.

In any of the embodiments described herein, the reference OCV cell may include at least one ion exchange separator.

In any of the embodiments described herein, the reference OCV cell includes an electrode for measuring the potential of the reference electrolyte, wherein the electrode may be spaced from the ion exchange separator by a distance of more than 0.1 m.

In any of the embodiments described herein, the reference OCV cell includes an electrode for measuring the potential of the reference electrolyte, wherein the electrode may be spaced from the ion exchange separator with a distance range of more than 0.1 m to 1.0 m.

In any of the embodiments described herein, the reference OCV cell includes an electrode for measuring the potential of the reference electrolyte, wherein the electrode may be spaced from the ion exchange separator by a distance of 0.1 m or less.

In any of the embodiments described herein, the electrolyte system in the redox flow battery may be selected from the group consisting of a V-sulfate system, a V-chloride system, a V-mixed sulfate and chloride system, a zinc-bromine system, a zinc-cerium system, a V-bromide system, a sodium polysulfide-bromide system, a V—Fe system, and a Fe—Cr system.

In any of the embodiments described herein, a method of operation may further include determining the state of charge values of the anolyte and catholyte working electrolytes based on the calculated potential values of the anolyte and catholyte working electrolytes.

In any of the embodiments described herein, a method of operation may further include detecting a difference in the calculated state of charge values of the anolyte and catholyte working electrolytes.

In any of the embodiments described herein, the state of charge values of the anolyte and catholyte working electrolytes may be determined from pre-measured state of charge and potential values.

In any of the embodiments described herein, a method of operation may further include controlling the operation of the redox flow battery based on the state of charge values of the anolyte and catholyte working electrolytes.

In any of the embodiments described herein, the difference between the calculated state of charge values of the anolyte and the catholyte may be selected from the group consisting of less than 20%, less than 10%, and less than 5%.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an isometric view of a redox flow battery (RFB) module in accordance with one embodiment of the present disclosure;

FIG. 2 is an isometric view of the RFB module of FIG. 1 with the outer container removed;

FIGS. 3A and 3B are schematic views of various components of the RFB module of FIGS. 1 and 2;

FIG. 4 is schematic view of a 1 MW site in accordance with one embodiment of the present disclosure;

FIG. 5 is a schematic view of a 10 MW site in accordance with one embodiment of the present disclosure;

FIG. 6 is a control diagram for a site, for example, the sites of FIG. 4 or 5;

FIGS. 7-9 are graphical depictions of data regarding capacity management in an exemplary vanadium RFB string;

FIG. 10 is a schematic view of an RFB module showing an exemplary open circuit voltage (OCV) measurement;

FIG. 11 is a schematic view of a RFB system including a primary OCV cell and a reference OCV cell in accordance with embodiments of the present disclosure;

FIGS. 12-14B are per-measured state-of charge and potential curves in accordance with embodiments of the present disclosure; and

FIGS. 15 and 16 are graphical representations of data from representative RFB systems including primary OCV cells and reference OCV cells in accordance with embodiment of the present disclosure.

### DETAILED DESCRIPTION

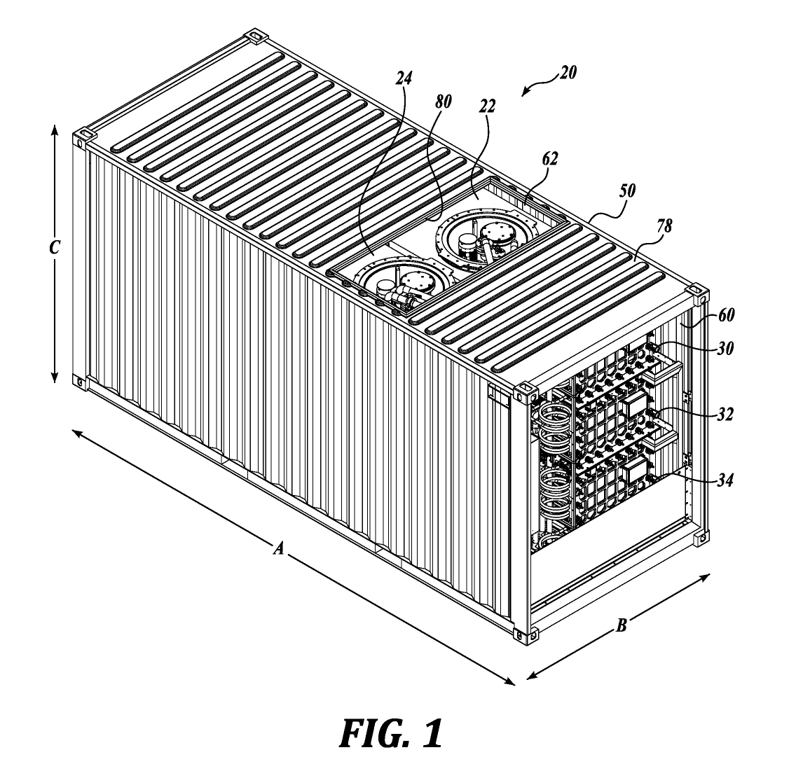

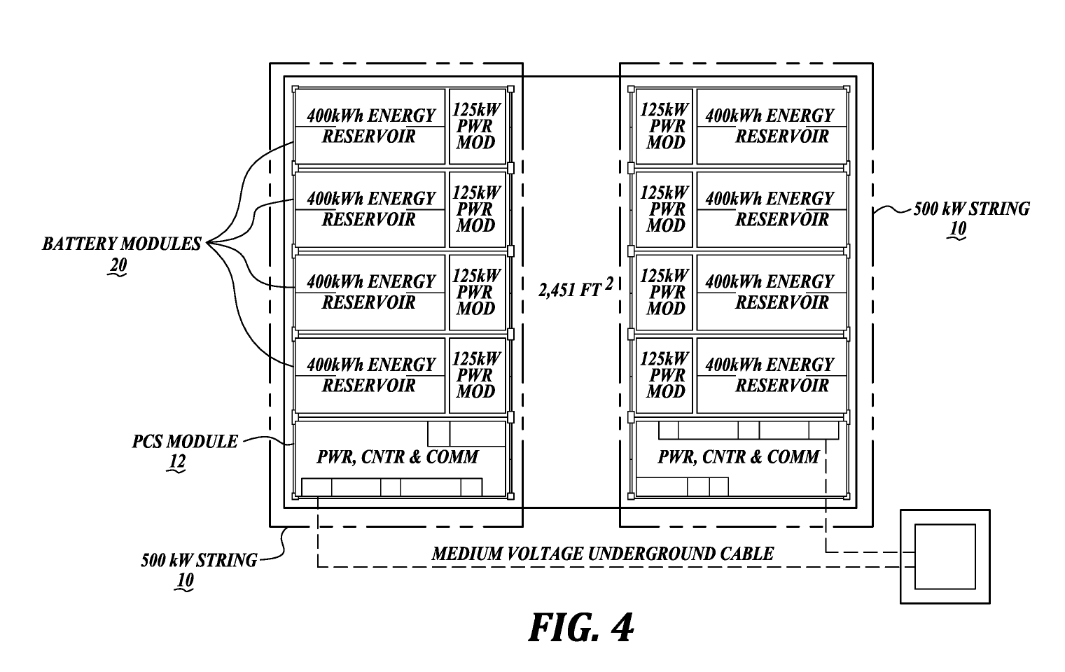

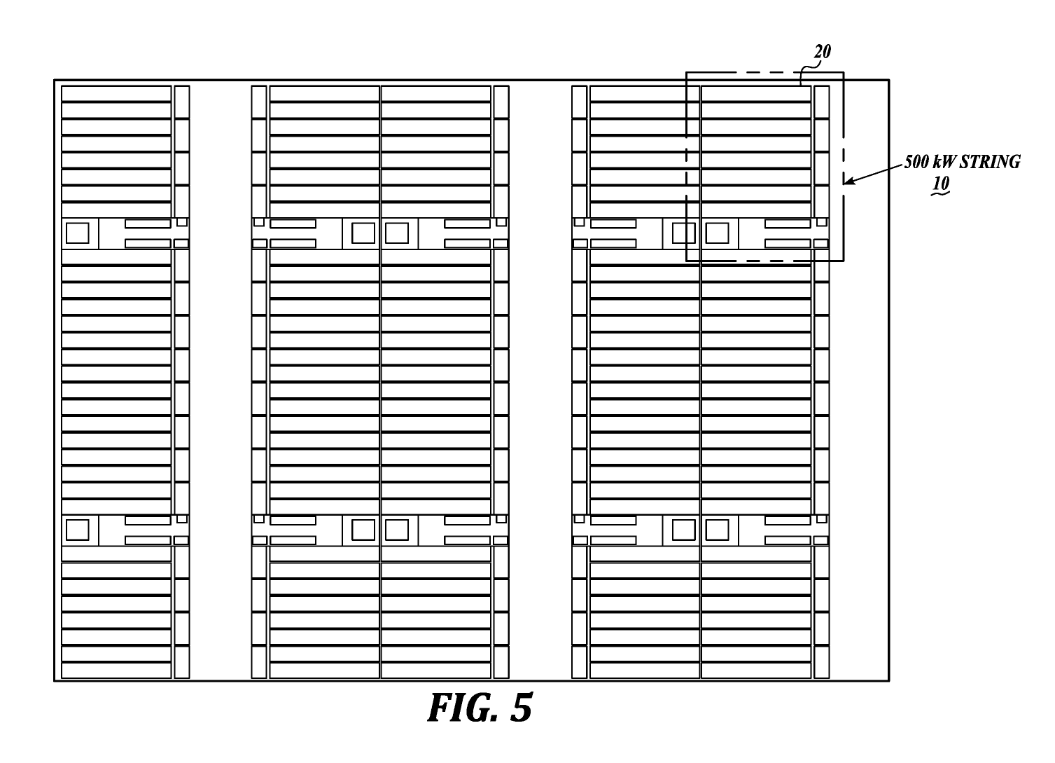

Embodiments of the present disclosure are directed to redox flow batteries (RFBs), systems and components thereof, stacks, strings, and sites, as well as methods of operating the same. Referring to FIGS. 1-3B, a redox flow battery 20 in accordance with one embodiment of the present disclosure is provided. Multiple redox flow batteries may be configured in a “string” of batteries, and multiple strings may be configured into a “site” of batteries. Referring to FIG. 4, a non-limiting example of a site is provided, which includes two strings 10, each having four RFBs 20. Referring to FIG. 5, another non-limiting example of a site is provided, which includes twenty strings 10, each having four RFBs 20. RFBs, systems and components thereof, stacks, strings, and sites are described in greater detail below.

### Redox Flow Battery

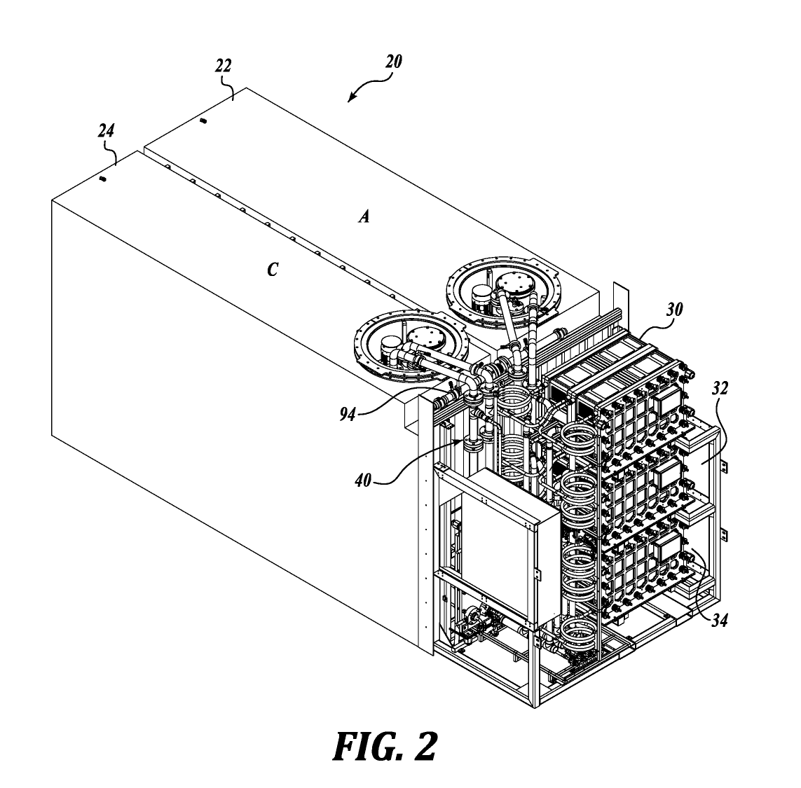

Referring to FIGS. 1 and 2, major components in an RFB 20 include the anolyte and catholyte tank assemblies 22 and 24, the stacks of electrochemical cells 30, 32, and 34, a system for circulating electrolyte 40, an optional gas management system 94, and a container 50 to house all of the components and provide secondary liquid containment.

In the present disclosure, flow electrochemical energy systems are generally described in the context of an exemplary vanadium redox flow battery (VRB), wherein a V³⁺/V²⁺ solution serves as the negative electrolyte (“anolyte”) and a V⁵⁺/V⁴⁺ solution serves as the positive electrolyte (“catholyte”). The vanadium system may be V-sulfate system, a V-chloride system, a V-mixed sulfate and chloride system. Other redox chemistries are also contemplated and within the scope of the present disclosure, including, as non-limiting examples, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺, etc.

As a non-limiting example, in a vanadium flow redox battery (VRB) prior to charging, the initial anolyte solution and catholyte solution each include the same or similar concentrations of V³⁺ and V⁴⁺. In another non-limiting example, the initial anolyte may include only V³⁺ active species. In another non-limiting example, the initial catholyte may include only V⁴⁺ active species. Upon charge, the vanadium ions in the anolyte solution are reduced to V²⁺/V³⁺ while the vanadium ions in the catholyte solution are oxidized to V⁴⁺/V⁵⁺. When state of charge (SOC) is 0%, all vanadium species in the anolyte are V³⁺ ions and all vanadium species in the catholyte are V⁴⁺ ions. When state of charge (SOC) is 100%, all vanadium species in the anolyte are V²⁺ ions and all vanadium species in the catholyte are V⁵⁺ ions.

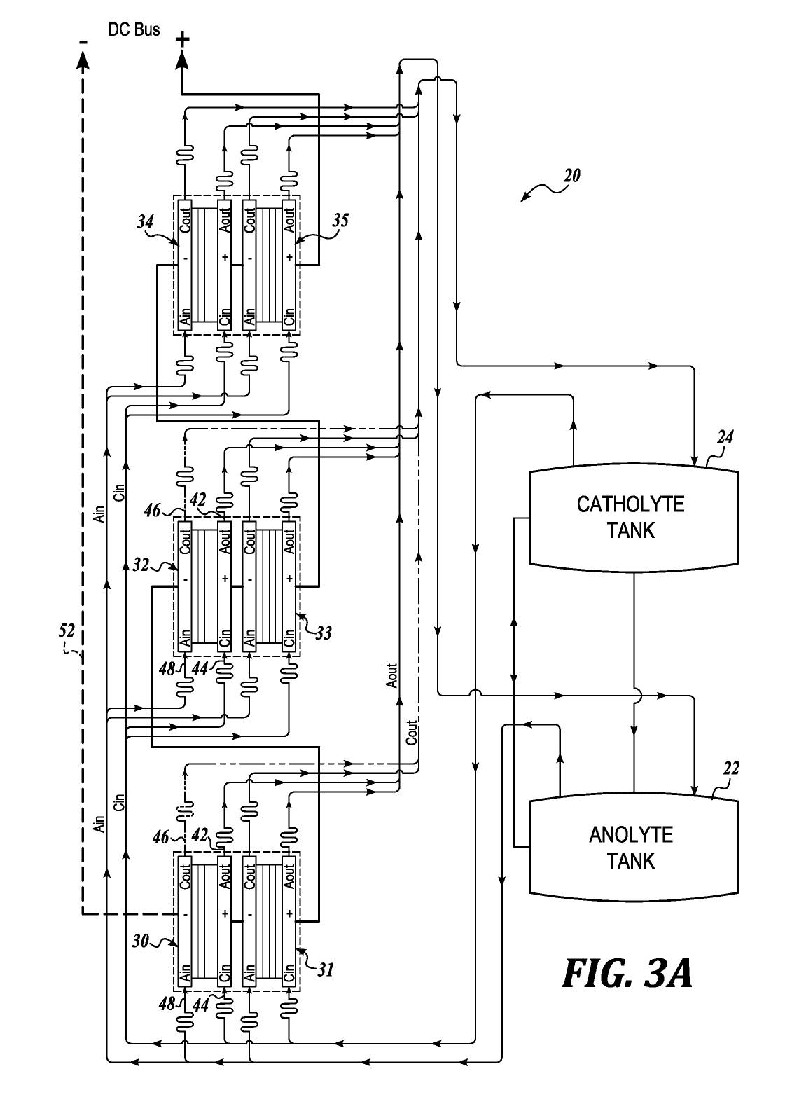

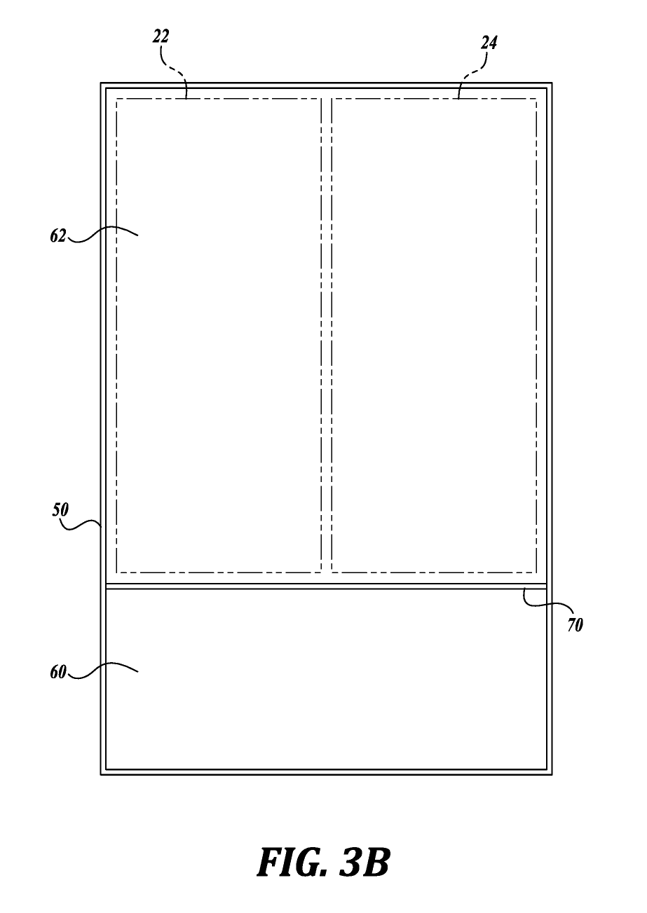

Referring to the schematic in FIG. 3A, general operation of the redox flow battery system 20 of FIGS. 1 and 2 will be described. The redox flow battery system 20 operates by circulating the anolyte and the catholyte from their respective tanks that are part of the tank assemblies 22 and 24 into the electrochemical cells, e.g., 30 and 32. (Although only two electrochemical cells are needed to form a stack of cells, additional electrochemical cells in the illustrated embodiment of FIG. 3A include electrochemical cells 31, 33 and 35.) The cells 30 and 32 operate to discharge or store energy as directed by power and control elements in electrical communication with the electrochemical cells 30 and 32.

In one mode (sometimes referred to as the “charging” mode), power and control elements connected to a power source operate to store electrical energy as chemical potential in the catholyte and anolyte. The power source can be any power source known to generate electrical power, including renewable power sources, such as wind, solar, and hydroelectric. Traditional power sources, such as combustion, can also be used.

In a second (“discharge”) mode of operation, the redox flow battery system 20 is operated to transform chemical potential stored in the catholyte and anolyte into electrical energy that is then discharged on demand by power and control elements that supply an electrical load.

Each electrochemical cell 30 in the system 20 includes a positive electrode, a negative electrode, at least one catholyte channel, at least one anolyte channel, and an ion transfer membrane separating the catholyte channel and the anolyte channel. The ion transfer membrane separates the electrochemical cell into a positive side and a negative side. Selected ions (e.g., H+) are allowed to transport across an ion transfer membrane as part of the electrochemical charge and discharge process. The positive and negative electrodes are configured to cause electrons to flow along an axis normal to the ion transfer membrane during electrochemical cell charge and discharge (see, e.g., line 52 in FIG. 3A). As can be seen in FIG. 3A, fluid inlets 48 and 44 and outlets 46 and 42 are configured to allow integration of the electrochemical cells 30 and 32 into the redox flow battery system 20.

To obtain high voltage, high power systems, a plurality of single electrochemical cells may be assembled together in series to form a stack of electrochemical cells (referred to herein as a “stack,” a “cell stack,” or an “electrochemical cell stack”), e.g., 30 or 32 in FIG. 3A. Several cell stacks may then be further assembled together to form a battery system 20. Stacks may be connected in strings in series or in parallel. A MW-level RFB system generally has a plurality of cell stacks, for example, with each cell stack having more than twenty electrochemical cells. As described for individual electrochemical cells, the stack is also arranged with positive and negative current collectors that cause electrons to flow through the cell stack generally along an axis normal to the ion transfer membranes and current collectors during electrochemical charge and discharge (see, e.g., line 52 shown in FIG. 3A).

Suitable ion transfer membranes may include cationic and anionic permeable barriers, for example, nonporous barriers, such as semi-permeable exchange membranes. A semi-permeable anion exchange membrane allows anions to pass but not non-anionic species, such as cations. A semi-permeable cation exchange membrane allows cations to pass but not non-cationic species, such as anions.

The nonporous feature of the barrier inhibits fluid flow across the membrane. Accordingly, an electric potential, a charge imbalance between the electrolytes on either side of the membrane, and/or differences in the concentrations of substances in the electrolytes can drive anions or cations across an anion or cation permeable barrier. In comparison to porous barriers, nonporous barriers are characterized by having little or no porosity or open space. In a normal electroplating reactor, nonporous barriers generally do not permit fluid flow when the pressure differential across the barrier is less than about 6 psi. Because the nonporous barriers are substantially free of open area, fluid is inhibited from passing through the nonporous barrier. Water, however, may be transported through the nonporous barrier via osmosis and/or electro-osmosis. Osmosis can occur when the molar concentration in the first and second processing fluids are substantially different. Electro-osmosis occurs as water is carried through the nonporous barrier with current-carrying ions in the form of a hydration sphere. When the first and second processing fluids have similar molar concentrations and no electrical current is passed through the processing fluids, fluid flow between the first and second processing fluids via the nonporous barrier is substantially prevented.

A nonporous barrier can be hydrophilic such that bubbles in the processing fluids do not cause portions of the barrier to dry, which reduces conductivity through the barrier.

In addition to the nonporous barriers described above, permeable barriers in accordance with embodiments of the present disclosure can also be porous barriers. Porous barriers include substantial amounts of open area or pores that permit fluid to pass through the porous barrier. Both ionic materials and nonionic materials are capable of passing through a porous barrier; however, passage of certain materials may be limited or restricted if the materials are of a size that allows the porous barrier to inhibit their passage. While useful porous barriers may limit the chemical transport (via diffusion and/or convection) of some materials in the first processing fluid and the second processing fluid, they allow migration of anionic species (enhanced passage of current) during application of electric fields associated with electrolytic processing. In the context of electrolytic processing a useful porous barrier enables migration of anionic species across the porous barrier while substantially limiting diffusion or mixing (i.e., transport across the barrier) of larger organic components and other non-anionic components between the anolyte and catholyte. Thus, porous barriers permit maintaining different chemical compositions for the anolyte and the catholyte. The porous barriers should be chemically compatible with the processing fluids over extended operational time periods. Examples of suitable porous barrier layers include porous glasses (e.g., glass frits made by sintering fine glass powder), porous ceramics (e.g., alumina and zirconia), silica aerogel, organic aerogels (e.g., resorcinol formaldehyde aerogel), and porous polymeric materials, such as expanded Teflon® (Gortex®).

At any given time during battery system 20 charging or discharging mode, reactions only occur for the electrolyte that is contained inside electrochemical cells. The energy stored in the battery system 20 increases or decreases according to the charging and discharging power applied to the electrochemical cells.

### String and Site Control System

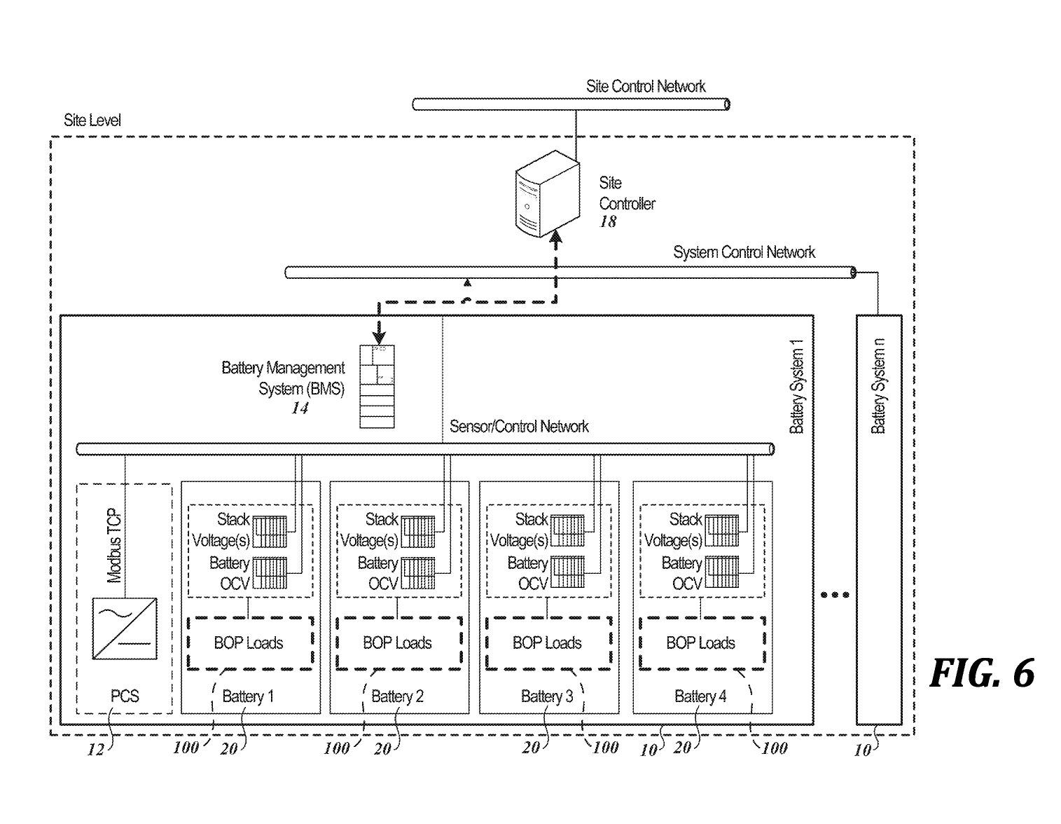

As noted above, a string 10 is a building block for a multiple MW site. As seen in the exemplary layouts in FIGS. 4 and 5, each string 10 includes four battery containers connected in series to a power and control system (PCS) 12 container. As can be seen in FIG. 6, the control system for each string includes a battery management system (BMS) 14 with local control provided, for example, by a human machine interface (HMI). The BMS 14 interprets remote commands from the site controller 18, for example, a customer requirement to charge or discharge, as it simultaneously directs the appropriate operations for each battery and sub-component in the string 10 via a communication network. At the same time, according to programmed logic, the BMS 14 interprets string 10 operating data from the batteries 20, PCS, and their associated sub-components to evaluate service or diagnose maintenance requirements. See also FIG. 6 for string and site control diagrams.

As a non-limiting example, an exemplary VRB may have capacity up to 125 kW for four hours (500 kW-hours) and a storage string may have capacity up to 500 kW for four hours (2 MW-hours). To be effective as a large scale energy storage system that can be operated to provide multiple layered value streams, individual batteries, designed and manufactured to meet economies of scale, may be assembled as building blocks to form multiple-megawatt sites, for example 5 MW, 10 MW, 20 MW, 50 MW, or more. Managing these large installations requires multi-level control systems, performance monitoring, and implementation of various communications protocols.

Referring to FIG. 4, an exemplary 1 MW system layout shows two 500 kW building block sub-assemblies or strings 10 that each include four battery modules 20 and one PCS module 102. Using this approach, multi-level larger systems may be assembled, for example, the single-level 10 MW system shown in FIG. 5.

### Battery Container System, Electrolyte Tank Assembly, and General Arrangement

Referring now to FIGS. 1 and 2, each RFB 20 includes a container 50 that houses the remaining components of the system in a substantially closed manner. These remaining components generally include the anolyte and catholyte tank assemblies 22 and 24, the stacks of electrochemical cells 30, 32, and 34, a system for circulating electrolyte 40, and an optional a gas management system 94. The configuration of each of these components will now be described in more detail.

FIG. 1 depicts the container 50 that houses, for example, the components shown in FIG. 2. The container 50 can be configured in some embodiments to be an integrated structure that facilitates or provides one or more of the following characteristics: compact design, ease of assembly, transportability, compact multiple-container arrangements and structures, accessibility for maintenance, and secondary containment.

In the illustrated embodiment of FIGS. 1 and 2, the representative container 50 comprises two major compartments that house components of the RFB 20. In some embodiments, the division between the first and second compartments 60 and 62 is a physical barrier in the form of a bulkhead 70 (see FIG. 3B), which may be a structural or non-structural divider. The bulkhead 70 in some embodiments can be configured to provide secondary containment of the electrolyte stored in tank assemblies 22 and 24. In another embodiment, a secondary structural or non-structural division can be employed to provide a physical barrier between the anolyte tank 22 and the catholyte tank 24. In either case, as will be described in more detail below, the tanks 22 and 24 are configured as so to be closely fitted within the compartment or compartments, thereby maximizing the storage volume of electrolyte within the container 50, which is directly proportional to the energy storage of the battery 20.

In some embodiments, the container 50 has a standard dimensioning of a 20 foot ISO shipping container. In one representative embodiment shown in FIGS. 1 and 2, the container has a length A which may be 20 feet, 8 feet in width B, and 9½ feet in height C, sometimes referred to as a High-Cube ISO shipping container. Other embodiments may employ ISO dimensioned shipping containers having either 8 feet or 8½ feet in height C, and in some embodiments, up to 53 feet in length A. In some of these embodiments, the container 50 can be additionally configured to meet ISO shipping container certification standards for registration and ease of transportation via rail, cargo ship, or other possible shipping channels. In other embodiments, the container may be similarly configured like an ISO shipping container. In other embodiments, the container has a length in the range of 10-53 feet and a height in the range of 7-10 feet.

The container 50 also includes various features to allow for the RFB 20 to be easily placed in service and maintained on site. For example, pass-through fittings are provided for passage of electrical cabling that transfers the power generated from circulation of the anolyte and the catholyte through the stacks of electrochemical cells. In some embodiments, the container 50 includes an access hatch 80, as shown in FIG. 1. Other hatches, doors, etc. (not shown) may be included for providing access to systems of the RFB 20.

### String Capacity Management of Electrolyte

Passive capacity management techniques have been shown to maintain stable performance under most conditions for a single battery. However, other operating conditions may occur that require active capacity management, especially on the string and site level.

Described herein are systems and methods of operation designed for improving performance on a string and site level. For example, in some embodiments of the present disclosure, performance can be improved by matching the state of charge when a string includes multiple batteries having different states of charge.

In one example, stack variation caused by differences in manufacturing assembly and materials may produce slightly different performance characteristics between each of the four RFBs 20 in a string 10 (see exemplary string diagrams in FIGS. 5 and 6), in some cases leading to different membrane ion transfer capabilities or different levels of side reactions, both of which contribute to performance mismatch in a string of batteries. One mechanism that may be affected by manufacturing differences in stacks can be seen during battery operation in the way ions travel back and forth through the membrane separating positive and negative electrolytes as they form a closed electrical circuit, and in the way water molecules travel through the membrane together with other hydrated ions or by themselves. As a result of stack differences, the volume of the positive and negative electrolytes and the concentrations of active ions in the electrolytes may change at different rates during battery operation.

In another example, stack variations caused by damage (leakage, blockage, etc.) to one or more stack cells may produce slightly different performance characteristics when the stacks are assembled as batteries and strings, and may also cause an imbalance in the predetermined battery tank volume ratio described above. Other reasons for stack variation may include differences in the electrode, stack compression, etc.

Because there may be performance differences between batteries in a string and all batteries in a string are electrically connected for charge and discharge operations, the worst performing battery may determine the performance of the string. Further, because each battery in the string has dedicated electrolyte tanks, lower performing batteries may continue to experience declining performance caused, for example by the by stack variation described above. Declining battery capacity is generally indicative of or may lead to electrolyte stability and capacity problems for the associated string. If left unchecked, these performance variations may result in decreased capacity across a string (or a site).

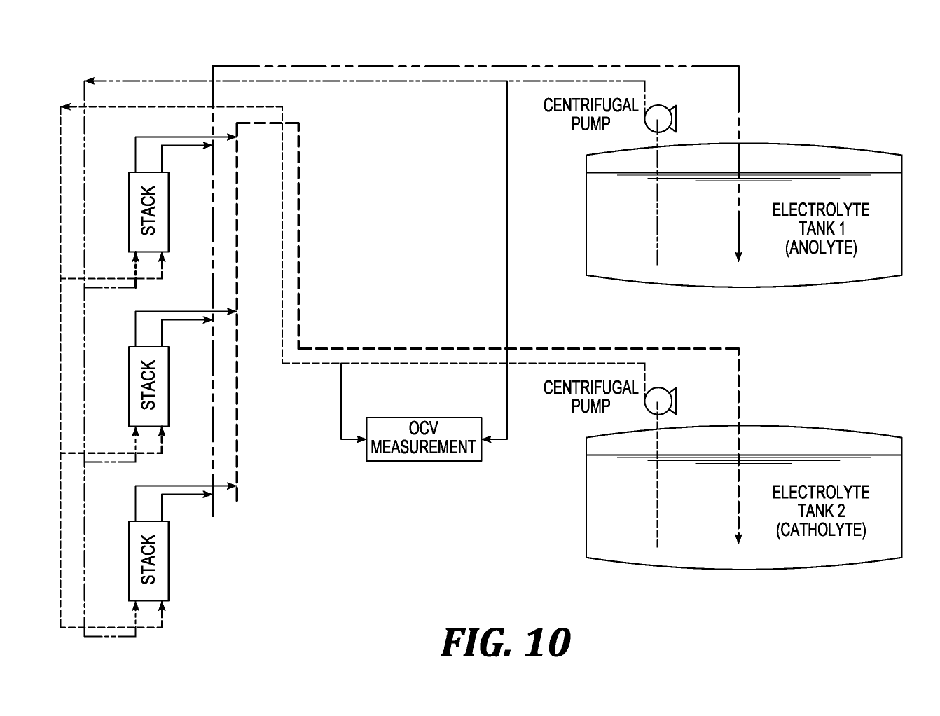

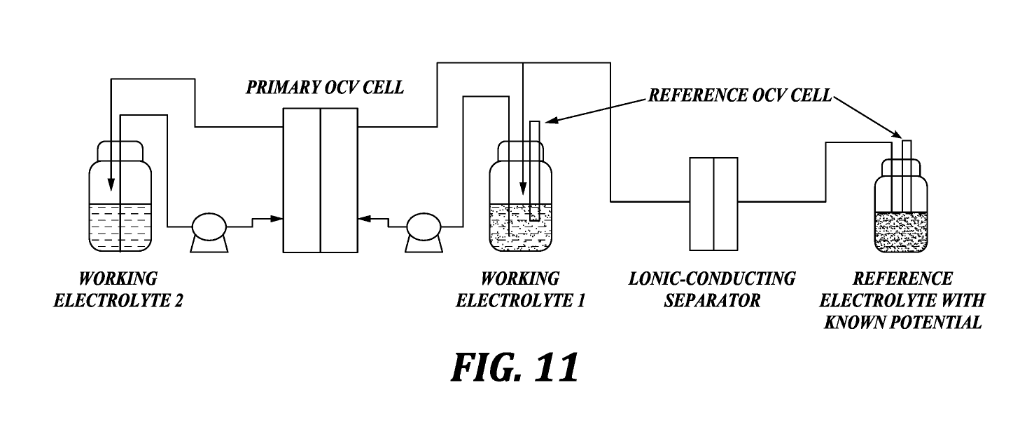

The possible effect of decreasing performance of one or more batteries in a string is illustrated below in EXAMPLES 1 and 2, using data based on open circuit voltage (OCV) values measured on the cell, stack, and battery level for each RFB in a string. OCV directly corresponds to state-of-charge (SOC) and is one measure of the SOC of a vanadium redox flow battery (VRFB). OCV is defined as the difference in electrical potential between two terminals of a device when it is disconnected from the circuit, for example, selected anolyte and catholyte reference points for each redox flow battery (see, e.g., OCV measurement point in FIG. 10).

Matching SOC in a string mitigates performance degradation of a battery string, as illustrated below in EXAMPLE 3.

### EXAMPLE 1

### Energy Density

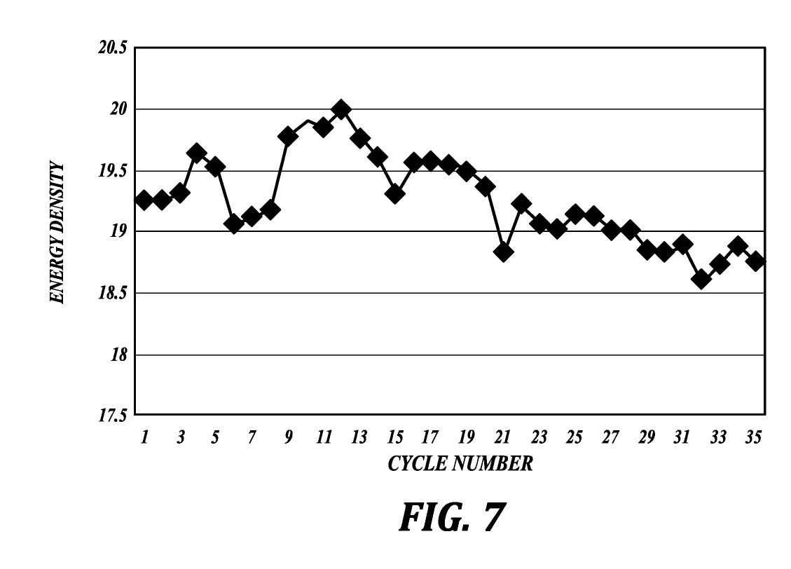

In a string of three, series-connected, kW-scale batteries without capacity management adjustments, a steady decline in energy density over 35 cycles can be seen in FIG. 7.

### EXAMPLE 2

### Open Circuit Voltage

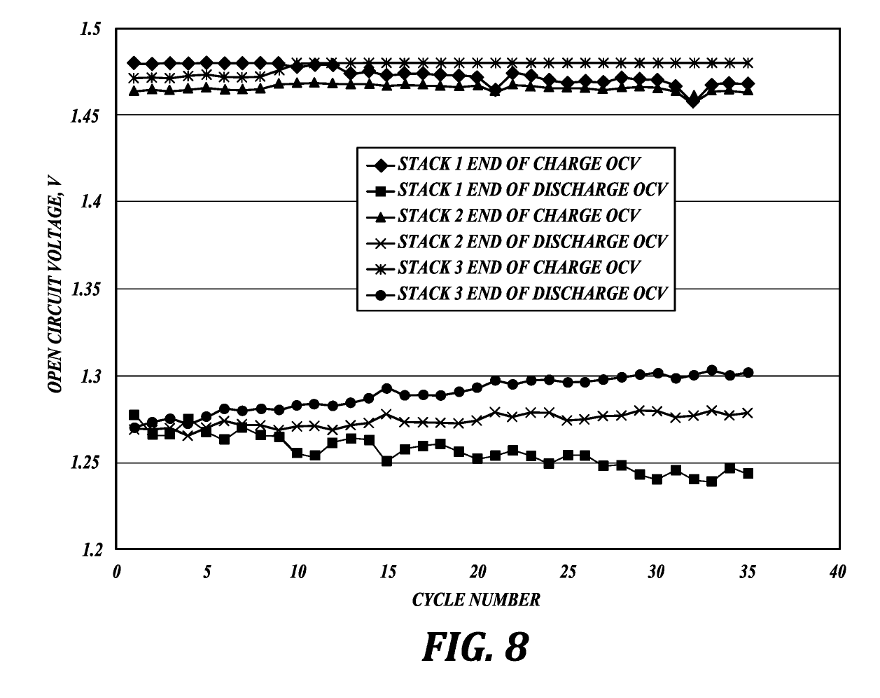

In a string of three, series-connected, kW-scale batteries without capacity management adjustments, a steady deviation in open circuit voltage (OCV) at the end of discharge over 35 cycles can be seen in FIG. 8.

### EXAMPLE 3

### Stack Performance Recovery

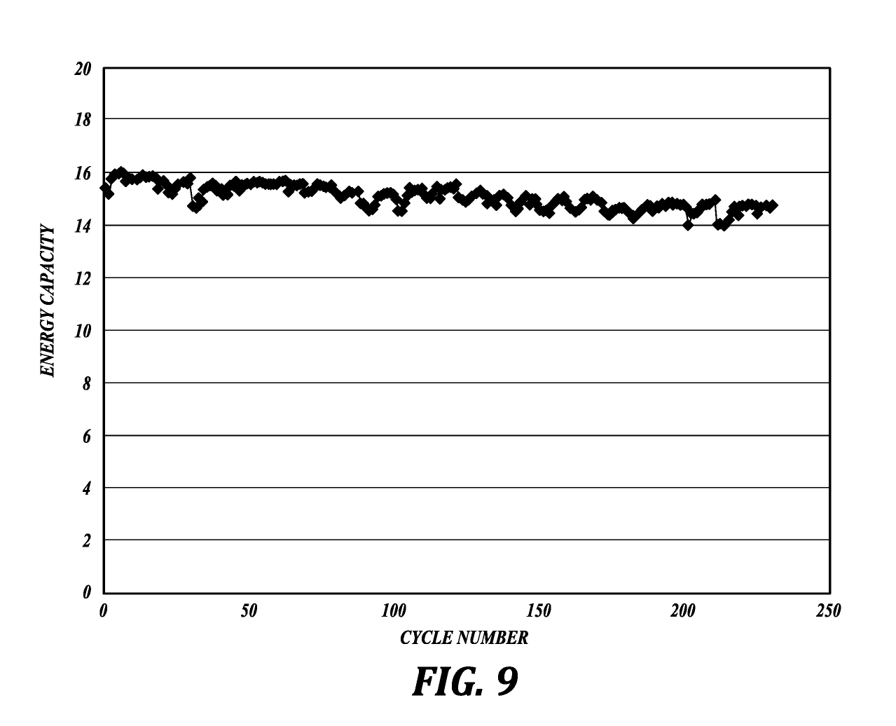

In a string of three, series-connected, kW-scale batteries with capacity management adjustments, an energy capacity decline of about 7% is shown in FIG. 9 for over 200 cycles. As compared to the energy density decline in FIG. 7 of about 7% over only 35 cycles, matching operation can mitigate performance degradation effects in one or more batteries in a string.

### Electrolyte State-of-Charge (SOC) in RFB

To manage battery capacity on the string (or site) level, state-of-charge (SOC) values can be determined and managed for each RFB. On the battery level, it is also generally desirable for the state of charge (SOC) of the anolyte and the catholyte to be matching or close to matching. Matching SOC between the anolyte and catholyte can help mitigate unwanted side reactions in the system, which may generate unwanted hydrogen if the anolyte SOC is too high or unwanted chlorine if the catholyte SOC is too high (if chloride species containing electrolytes are used in the battery). When the SOC values of the anolyte and catholyte are known, the system can be adjusted to return to the target values or target value ranges.

For “matching”, the acceptability of the difference between the SOC values of the anolyte and the catholyte depends on the battery system. In one embodiment of the present disclosure, the difference between the SOC values of the anolyte and the catholyte is less than 20%. In one embodiment of the present disclosure, the difference between the SOC values of the anolyte and the catholyte is less than 10%. In another embodiment of the present disclosure, the difference between the SOC values of the anolyte and the catholyte is less than 5%. In another embodiment of the present disclosure, the different between the SOC values of the anolyte and the catholyte is reduced to mitigate side reactions to an acceptable level.

The SOC values of the anolyte and the catholyte can change over time with multiple cycles, often becoming unbalanced or unmatched over time. During operation, real-time monitoring of the status of the electrolytes in a RFB provides information on the operation of the RFB. Real-time monitoring of SOC is typically achieved by measuring the OCV of the positive and negative electrodes using a single-cell type OCV measurement device (see FIG. 10). (Other ways of determining SOC besides OCV are also within the scope of the present disclosure, such as recording and analyzing the amount of energy entering and leaving the battery over a given time period, which may be referred to as coulomb counting.)

One drawback of OCV measurement is that OCV tells the voltage difference of the positive and negative electrolytes, but does not provide a reference voltage value. In a well-balanced system, the OCV signal can be converted to the charge or discharge status of each electrolyte. However, when the SOC of the positive and negative electrolytes are not balanced, using the voltage difference of the positive and negative electrolytes to predict the SOC of the electrolytes is not accurate. Further, using OCV to control an unbalanced battery operation can be dangerous in the event side reactions generate unwanted hydrogen or chlorine.

### Reference Electrolyte for Determining Voltage Values

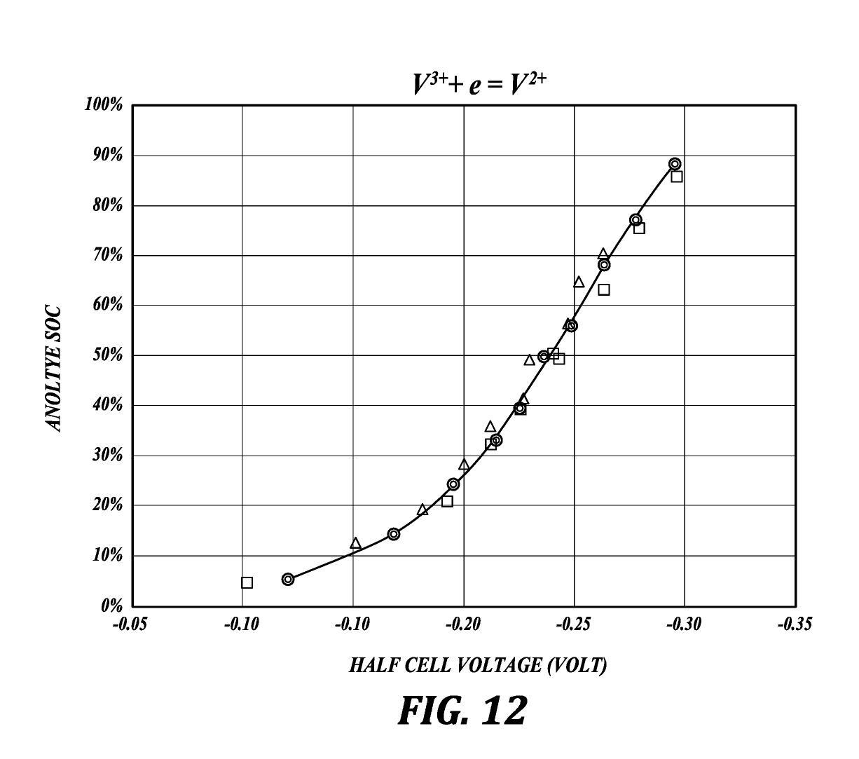

Referring to FIG. 12, in a battery system, a primary OCV cell measures the voltage difference between the positive and negative electrolytes in working electrolyte 1 and working electrolyte 2. In addition to the primary OCV cell, a reference OCV cell measures the voltage difference between a reference electrolyte and working electrolyte 1 or working electrolyte 2. In the illustrated embodiment of FIG. 12, the reference OCV cell measures the voltage difference between a reference electrolyte and working electrolyte 2. However, the system may be configured for the reference OCV cell to measures the voltage difference between a reference electrolyte and working electrolyte 1. Because the reference electrolyte has a known electrochemical potential, the reference electrolyte can be used in a battery system to determine the OCV values of the working positive and negative electrolytes, and not just the voltage difference of the positive and negative electrolytes.

The primary OCV cell and the reference OCV cell each include an ion conducting separator to separate the electrolytes and measure the voltage difference of the positive and negative electrolytes. The reference electrolyte is either a positive or negative electrolyte depending on the configuration of the system or preference for operation of the system. For example, if a catholyte is used as the reference electrolyte, it can be paired with the working anolyte or with the working catholyte in the reference OCV cell. It may be advantageous to pair the reference catholyte with the working catholyte to minimize the reference electrolyte concentration change due to diffusion crossing the membrane. If the reference electrolyte is an anolyte, it can be paired with the working catholyte or with the working anolyte in the reference OCV cell. It may be advantageous to pair the reference anolyte with the working anolyte to minimize the reference electrolyte concentration change due to diffusion crossing the membrane.

The reference electrode measuring the potential difference between the working electrolyte and the reference electrolyte is either placed away from or close to the ion conducting separator for measurement accuracy. In some systems, placing the reference electrode away from the ion conducting separator helps to reduce contamination of the electrode. If the electrode is close to the membrane, it can be more easily contaminated resulting in a dropping of the potential of the reference electrode over a shorter period of time. However, close positioning can be tolerated in the system with adjustment of control parameters. In some systems a suitable distance between the electrode and the ion conducting separator may reduce contamination. However, a spacing distance between the electrode and the ion conducting separator of greater than 1 m may reduce the accuracy of the electrode.

In one embodiment of the present disclosure, a reference electrode placed close to the ion conducting separator is within 0.1 m of the ion conducting separator. In another embodiment of the present disclosure, a reference electrode placed away from the ion conducting separator is distanced more than 0.1 m away from the ion conducting separator. In another embodiment of the present disclosure, a reference electrode is spaced from the ion conducting separator a distance of more than 0.1 m to 1.0 m from the ion conducting separator.

In accordance with embodiments of the present disclosure, calculations to determine the OCV values of the working positive and negative electrolytes are as follows.
(1) Determine the voltage difference between a known reference electrolyte voltage and working electrolyte 2 using a reference OCV cell.
(2) Calculate the voltage of working electrolyte 2.
(3) Determine the voltage difference working electrolyte 2 and working electrolyte 1 using a primary OCV cell.
(4) Calculate the voltage of working electrolyte 1.

### EXAMPLE 4

### Exemplary Voltage Calculations Using Reference Electrolyte

In an exemplary vanadium redox battery system with a reference electrolyte having a composition of 50% state of charge of the working electrolyte, the following exemplary calculations can be used to determine the voltage of the positive and negative working electrolytes in the system.

Positive Working Electrolyte: VO²⁺+H₂O−e⁻=VO₂⁺+2H⁻ (potential V_{Pw}).

Negative Working Electrolyte: V³⁺+e⁻=V²⁺ (potential V_{Nw}).

Reference Electrolyte: VO²⁺+H₂O−e⁻=VO₂⁺+2H⁺ (potential V_{R}).
V_{Pw}=Reference OCV+V_{R}.
V_{Nw}=Reference OCV+V_{R}−Primary OCV.

Obtain state of charge of positive working electrolyte via a premeasured function:

SOC_{P}=f(V_{Pw}).

Obtain state of charge of negative working electrolyte via a premeasured function:

SOC_{N}=f(V_{Nw}).

### Obtaining State of Charge (SOC)

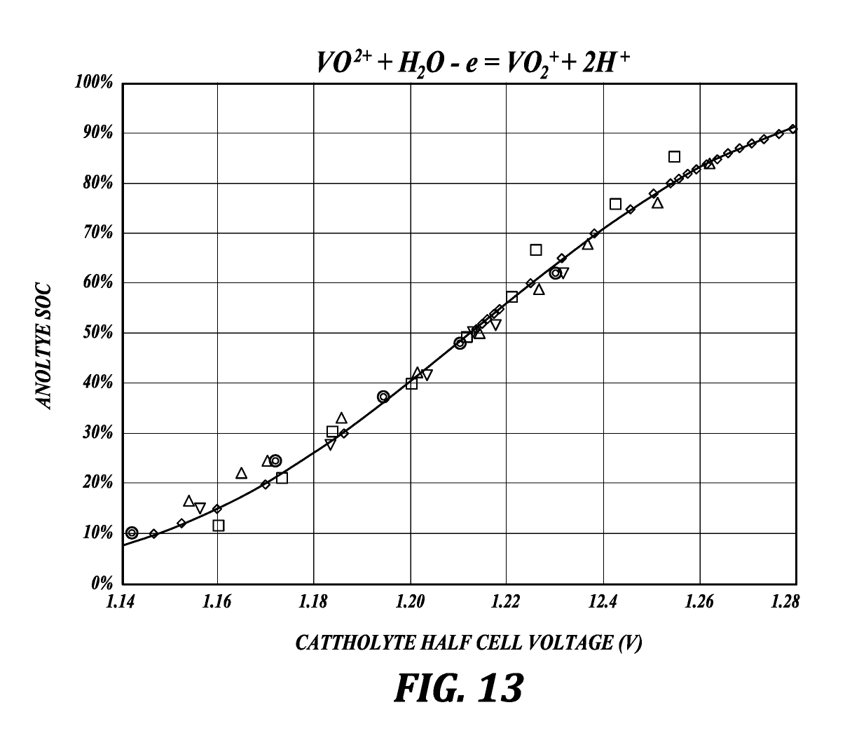

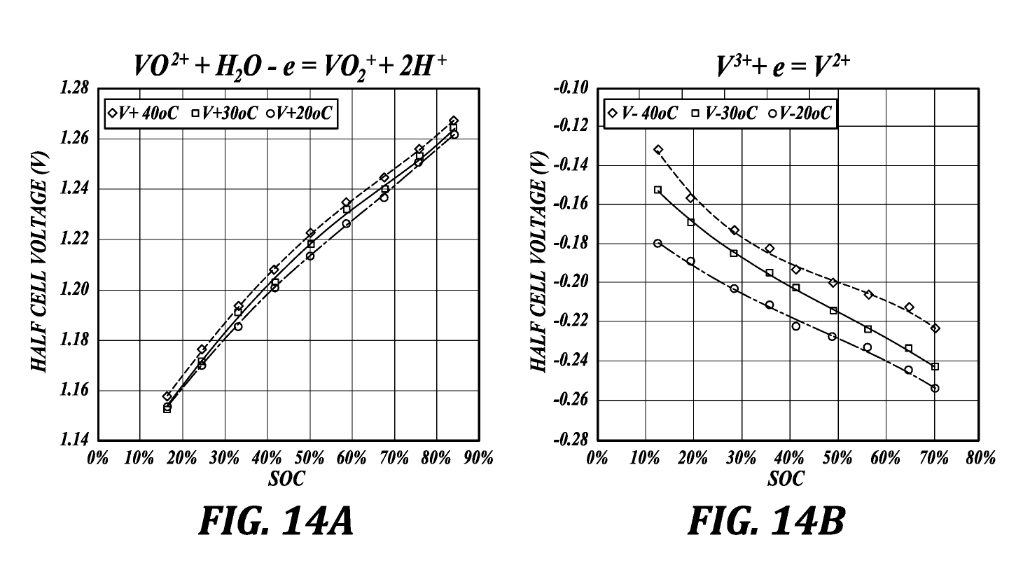

As discussed above in EXAMPLE 4, the state of charge (SOC) values for the working electrolytes are determined via a premeasured function. In accordance with one embodiment of the present disclosure, the state of charge value for each working electrolyte can be determined using from pre-measured SOC-potential curves. Referring to FIGS. 13 and 14, exemplary calibration curves are provided for exemplary working electrolytes based on data obtained for a specific system. In FIG. 13, with a known half-cell voltage (with respect to a standard hydrogen electrode (SHE)), the anolyte SOC can be determined based on the calibration curve. In FIGS. 12 and 13, with a known half-cell voltage (with respect to SHE), the catholyte SOC can be determined based on the calibration curve.

Referring to FIGS. 14A and 14B, other exemplary calibration curves are provided based on the temperature of the electrolyte. In addition to temperature, other factors may affect the calibration curves for a specific system.

With real-time SOC values of each working electrolyte, the battery can be monitored and controlled for optimal performance. For example, the active material concentration for each working electrolyte can be calculated based on SOC changes for a given amount of charged or discharged electricity. For any given quantity electricity charged or discharged, the active material ratio between the positive and negative working electrolytes equals to the reciprocal of their SOC change ratio. With a known total amount of active material in the system and a known volume of each working electrolyte, the amount and concentration of each active species in the system at any given state can be calculated.

In addition, with the data mentioned above, the average oxidation state (AOS) of the catholyte and the anolyte of the battery can be calculated based on the calculated the state of charges of the anolyte and catholyte working electrolytes and the known amount of total active materials and electrolyte volumes in the system. AOS values for the catholyte and the anolyte can provide information on the operation of the system, for example, whether the system is in or out of balance or whether the system is causing unwanted side reactions.

In one embodiment of the present disclosure, the average oxidation state values of the anolyte and the catholyte are monitored and maintained between 3.40 and 3.60. In another embodiment of the present disclosure, the average oxidation state values of the anolyte and the catholyte are monitored and maintained between 3.45 and 3.55. AOS values can be adjusted back to desired value ranges by varying the relative amounts of active materials in the catholyte and anolyte electrolytes, such as performing reduction or oxidation, adding or subtracting a certain amount of catholyte or anolyte, etc.

The AOS calculation for all vanadium flow batteries:

$$AOS = \frac{2 * n 2 + 3 * n 3 + 4 * n 4 + 5 * n 5}{n 2 + n 3 + n 4 + n 5} = \frac{Σ vi * ni}{Σ ni}$$

vi: valence of the vanadium species

ni: molar number of vanadium species with valence i, with i=2, 3, 4, and 5.

### The Reference Electrolyte

In accordance with some embodiments of the present disclosure, the reference electrolyte has the same or substantially the same composition of the working electrolyte.

In embodiments of the present disclosure, the state of charge (SOC) of the reference electrolyte is between 0% and 100%. As discussed above as a non-limiting example, in a vanadium flow redox battery (VRB) prior to charging, the initial anolyte solution and catholyte solution each include the same or similar concentrations of V³⁺ and V⁴⁺. Upon charge, the vanadium ions in the anolyte solution are reduced to V²⁺/V³⁺ while the vanadium ions in the catholyte solution are oxidized to V⁴⁺/V⁵⁺. For a catholyte reference electrolyte with 0% SOC, the vanadium ions in the catholyte are all V⁴⁺. For a catholyte reference electrolyte with 100% SOC, the vanadium ions in the catholyte are all V⁵⁺. For an anolyte reference electrolyte with 0% SOC, the vanadium ions in the catholyte are all V³⁺. For an anolyte reference electrolyte with 100% SOC, the vanadium ions in the catholyte are all V²⁺.

In some embodiments of the present disclosure, the state of charge of the reference electrolyte is between 30% and 60%. In other embodiment, the state of charge of the reference electrolyte is between 40% and 50%. In non-limiting EXAMPLE 5 below, an exemplary reference electrolyte in a VRFB system having a state of charge (SOC) of 48.8% is provided. In non-limiting EXAMPLE 6 below, in another exemplary reference electrolyte in a VRFB system having a state of charge (SOC) of 41.4% is provided.

The reference electrolyte and the reference OCV cell are designed for reliability of the reference electrolyte for control of known voltage over an extended period of time. For comparison, in previously designed reference cells using a silver chloride electrode or a mercury chloride electrode (calomel electrode), the reference cell could not maintain its reference potential over an extended period of time due to species in the electrolytes crossing over the reference junction or salt bridge, which causes the contamination of the reference electrolyte. Therefore, the use of an electrolyte different than the working electrolyte (such as silver chloride or mercury chloride) created potential problems in system operation.

### EXAMPLE 5

### Reference Electrolyte Stability

An exemplary catholyte reference electrolyte in a VRFB test system is 100 ml of 48.8% SOC catholyte with a glass carbon electrode. The catholyte reference electrode is away from the membrane spaced by a distance of more than 0.1 m. The reference half-cell voltage was determined by measuring the OCV of the catholyte reference electrode (Vref) vs. an Ag/AgCl (3M KCl) reference electrode. The data shows the voltage of the catholyte reference electrolyte did not statistically change over a period of 84 days.

| | | | Vref. vs. | |
|---|---|---|---|---|
| Day | Temp. | SOC | Ag/AgCl (V) | Remark |
| 1 | 20.0° C. | 48.5 ± 0.5% | 1.001 ± 0.001 | Fresh CA reference |
| 7 | 24.0° C. | 48.8 ± 0.5% | 1.003 ± 0.001 | CA Reference at test |
| | | | | battery #3 |
| 14 | 25.0° C. | 48.7 ± 0.5% | 1.004 ± 0.001 | CA Reference at test |
| | | | | battery #3 |
| 27 | 23.8° C. | 47.1 ± 0.5% | 1.003 ± 0.001 | CA Reference at test |
| | | | | battery #3 |
| 84 | 23.8° C. | 47.1 ± 0.5% | 0.998 ± 0.001 | CA Reference at test |
| | | | | battery #3 |

### EXAMPLE 6

### Reference Electrolyte Stability

Another exemplary catholyte reference electrolyte in a VRFB test system is 100 ml of 41.4% SOC catholyte with a carbon felt electrode that is placed close to the catholyte working electrolyte separated with an ionic membrane, within a distance of 0.1 m. The reference half-cell voltage was determined by measuring the OCV of the catholyte reference electrode (Vref.) vs. an Ag/AgCl (3M KCl) reference electrode. The data shows the voltage of the catholyte reference electrolyte had slight changes over a period of 76 days. Comparing the results of Example 6 with the results of Example 5, dropping of the potential of the reference electrode is observed over a shorter period of time as a result of the close spacing of the reference electrode to the ionic membrane.

| | | | Vref. vs. | |
|---|---|---|---|---|
| Day | Temp. | SOC | Ag/AgCl (V) | Remark |
| 1 | 24.2° C. | 41.4 ± 0.5% | 0.993 ± 0.001 | Fresh CA reference |
| 76 | 24.0° C. | 37.8 ± 0.5% | 0.982 ± 0.001 | CA Reference at test |
| | | | | battery #4 |

### System Data

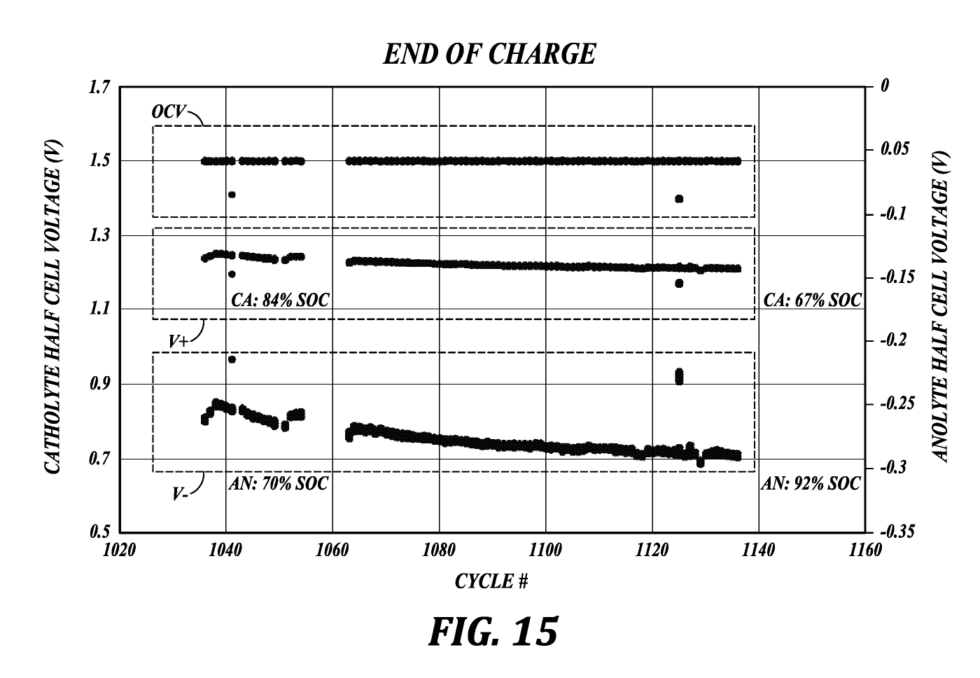

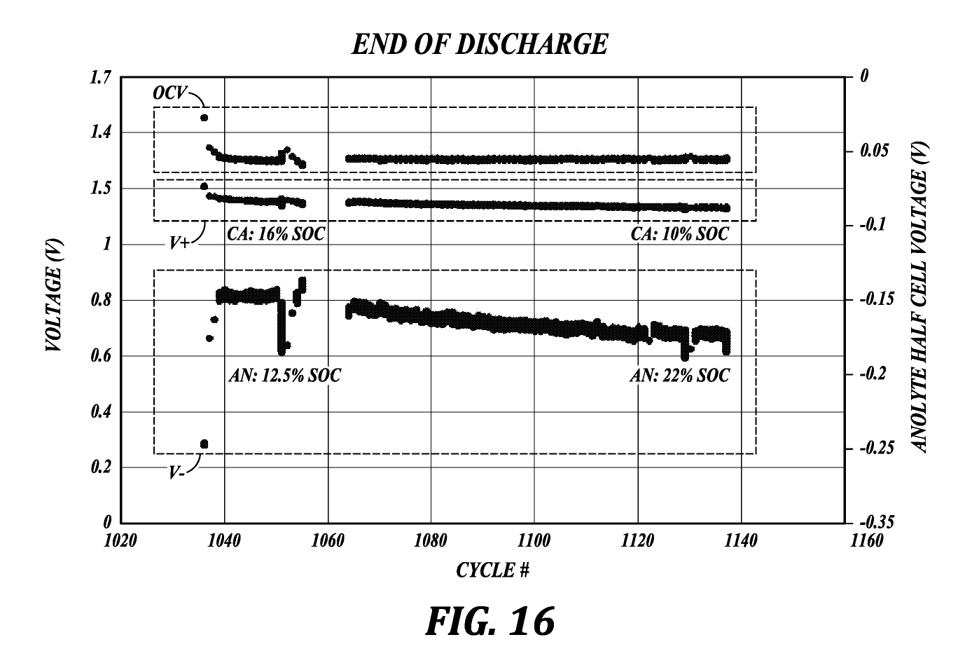

Referring to FIGS. 15 and 16, two VRFB system examples are provides, as explained in detail below.

### EXAMPLE 6

### End of Charge Data

In a collection of end of charge data for an exemplary VRFB system, half-cell voltage values for a primary OCV cell voltage, a catholyte, and an anolyte are provided over a period of 1035 to 1135 cycles. The top line of data shows voltage for the primary OCV cell voltage, which is substantially constant over the period of cycles. While the data for the primary OCV cell voltage is substantially constant, the data for the catholyte and anolyte show changes in the catholyte and anolyte state of charge. The middle line of data shows the state of charge of the catholyte decreasing from 84% to 67% over the period of cycles. The bottom line of data shows the state of charge of the anolyte increasing from 70% to 92% over the period of cycles.

If the system did not use a reference OCV cell, and only used a primary OCV cell, the data would only reveal the voltage difference of the positive and negative electrolytes, but would not provide a reference voltage value. In examining the voltage difference of the positive and negative electrolytes over the period of cycles, the SOC difference between catholyte and anolyte at 1040 cycles would be 14% (84% CA SOC-70% AN SOC) and at 1130 cycles would be 25% (92% AN SOC-67% CA SOC). Such a change in SOC difference may not be remarkable to a system controller.

However, in examining the actual voltage values, and not only the voltage difference of the positive and negative electrolytes, the decrease in catholyte SOC from 84% CA SOC to 67% CA SOC and the increase in anolyte SOC from 70% AN SOC to 92% AN SOC may help detect a problem in the system as the catholyte and anolyte move away from having matching or close to matching SOC values. For example, increasing anolyte may result in the generation of unwanted hydrogen in the system can be detected.

### EXAMPLE 7

### End of Discharge Data

In a collection of end of discharge data for an exemplary VRFB system, half-cell voltage values for a primary OCV cell, a catholyte, and an anolyte are provided over a period of 1035 to 1135 cycles. The top line of data shows voltage for primary OCV cell, which is substantially constant over the period of cycles. While the data for the primary OCV cell voltage is substantially constant, the data for the catholyte and anolyte show changes in the catholyte and anolyte state of charge. The middle line of data shows the state of charge of the catholyte decreasing from 16% to 10% over the period of cycles. The bottom line of data shows the state of charge of the anolyte increasing from 12.5% to 22% over the period of cycles.

If the system did not use a reference OCV cell, and only used a primary OCV cell, the data would only reveal the voltage difference of the positive and negative electrolytes, but would not provide a reference voltage value. In examining the voltage difference of the positive and negative electrolytes over the period of cycles, the SOC difference between catholyte and anolyte at 1040 cycles would be 3.5% (16% CA SOC-12.5% AN SOC) and at 1130 cycles would be 12% (22% AN SOC-10% CA SOC). Such a change in SOC difference may not be remarkable to a system controller.

However, in examining the actual voltage values, and not only the voltage difference of the positive and negative electrolytes, the decrease in catholyte SOC from 16% CA SOC to 12.5% CA SOC and the increase in anolyte SOC from 22% AN SOC to 10% AN SOC may help detect a problem in the system as the catholyte and anolyte move away from having matching or close to matching SOC values. For example, increasing anolyte may result in the generation of unwanted hydrogen in the system can be detected.

While illustrative embodiments have been illustrated and described, it will be appreciated that various changes can be made therein without departing from the spirit and scope of the disclosure.

1. A redox flow battery, comprising:
an electrochemical cell in fluid communication with anolyte and catholyte working electrolytes, and a primary OCV cell to measure the potential difference between the positive and negative working electrolyte; and
a reference OCV cell to measure the potential difference between the reference cell working electrolyte, which is one of the anolyte and catholyte working electrolytes, and a reference electrolyte, wherein the reference electrolyte has a known potential.

2. The redox flow battery of claim 1, wherein the reference electrolyte has ions of the same metal as the reference cell working electrolyte.

3. The redox flow battery of claim 1, wherein the reference electrolyte and the reference cell working electrolyte include an initial electrolyte mixture of V³⁺ and V⁴⁺ ions or one of V³⁺ and V⁴⁺ ions.

4. The redox flow battery of claim 1, wherein the reference electrolyte and the reference cell working electrolyte are both catholytes or both anolytes.

5. The redox flow battery of claim 1, wherein one of the reference electrolyte and the reference cell working electrolyte is a catholyte and the other is an anolyte.

6. The redox flow battery of claim 1, wherein the state of charge of the reference electrolyte is between 0% and 100%.

7. The redox flow battery of claim 1, wherein the state of charge of the reference electrolyte is between 30% and 60%.

8. The redox flow battery of claim 1, wherein the state of charge of the reference electrolyte is between 40% and 50%.

9. The redox flow battery of claim 1, wherein the reference OCV cell includes at least one ion exchange separator.

10. The redox flow battery of claim 9, wherein the reference OCV cell includes an electrode for measuring the potential of the reference electrolyte, wherein the electrode is spaced from the ion exchange separator by a distance of more than 0.1 m.

11. The redox flow battery of claim 9, wherein the reference OCV cell includes an electrode for measuring the potential of the reference electrolyte, wherein the electrode is spaced from the ion exchange separator with a distance range of more than 0.1 m to 1.0 m.

12. The redox flow battery of claim 9, wherein the reference OCV cell includes an electrode for measuring the potential of the reference electrolyte, wherein the electrode is spaced from the ion exchange separator by a distance of 0.1 m or less.

13. The redox flow battery of claim 1, wherein the electrolyte system in the redox flow battery is selected from the group consisting of a V-sulfate system, a V-chloride system, a V-mixed sulfate and chloride system, a zinc-bromine system, a zinc-cerium system, a V-bromide system, a sodium polysulfide-bromide system, a V—Fe system, and a Fe—Cr system.

14. A method of operating a redox flow battery, the method comprising:
providing an electrochemical cell in fluid communication with anolyte and catholyte working electrolytes, and a primary OCV cell to measure a first potential difference between the positive and negative working electrolyte, and a reference OCV cell to measure a second potential difference between the reference cell working electrolyte, which is one of the anolyte and catholyte working electrolytes, and a reference electrolyte, wherein the reference electrolyte has a known potential; and
calculating the potential values of the anolyte and catholyte working electrolytes based on the known potential values of the reference electrolyte and the first and second potential difference values obtained from the primary OCV cell and the reference OCV cell.

15. The method of claim 14, further comprising determining the state of charge values of the anolyte and catholyte working electrolytes based on the calculated potential values of the anolyte and catholyte working electrolytes.

16. The method of claim 15, further comprising detecting a difference in the calculated state of charge values of the anolyte and catholyte working electrolytes.

17. The method of claim 15, wherein the state of charge values of the anolyte and catholyte working electrolytes are determined from pre-measured state of charge and potential values.

18. The method of claim 15, further comprising controlling the operation of the redox flow battery based on the state of charge values of the anolyte and catholyte working electrolytes.

19. The method of claim 16, wherein the difference between the calculated state of charge values of the anolyte and the catholyte is selected from the group consisting of less than 20%, less than 10%, and less than 5%.
